(19) United States
(12) Patent Application Publication
(10) Pub. No.: US 2007/0262660 A1
(43) Pub. Date: Nov. 15, 2007

(54) Stepping motor

(76) Inventors: Shinichi Utsumi, Nagano (JP); Takeyoshi Miyashita, Nagano (JP); Masaki Yokoyama, Nagano (JP)

Correspondence Address: CANTOR COLBURN, LLP, 55 GRIFFIN ROAD SOUTH, BLOOMFIELD, CT, 06002, US

(21) Appl. No.: 11/799,085

(22) Filed: Apr. 30, 2007

(30) Foreign Application Priority Data
May 1, 2006 (JP) 2006-127582
Apr. 19, 2007 (JP) 2007-110914

(51) Int. Cl. H02K 37/14; H02K 37/12

(52) U.S. Cl. 310/49 R

(57) ABSTRACT

A stepping motor may include a rotor and a stator assembly. The stator assembly may include a first coil, a second coil, a first stator core and a second stator core. Each of the stator may include an end plate part for forming a rotor insertion hole and a plurality of pole teeth bent from an inner circumferential edge of the rotor insertion hole. The end plate part may be formed in a rectangular shape which has a pair of facing long sides extended in a direction where the first coil and the second coil are disposed. Further, portions of one of the first and the second stator cores, which face tip end portions of the pole teeth formed from the other stator core, are formed as cutout portions by cutting out in an outer radial direction from the rotor insertion hole, and at least one of the cutout portions which are located nearest to the long sides is formed as a first cutout portion where the cutout portion reaches to the long side.

### CROSS REFERENCE TO RELATED APPLICATION

The present invention claims priority under 35 U.S.C. § 119 to Japanese Application No. 2006-127582 filed May 1, 2006, and Japanese Application No. 2007-110914 filed Apr. 19, 2007, both of which are incorporated herein by reference.

### FIELD OF THE INVENTION

The present invention relates to a stepping motor.

### BACKGROUND OF THE INVENTION

Stepping motors have been used in various types of devices and, in some devices, a stepping motor has been strongly required to be made thinner. For a stepping motor which is capable of coping with this requirement, a structure has been proposed in which, in a state that a rotor shaft of a rotor is horizontally placed, an upper portion and a lower portion of a stator are cut out and coils are disposed on both sides of a rotor magnet (see, for example, Japanese Patent Laid-Open No. Hei 1-99466).

The stepping motor having the structure as described above is, similarly to an ordinary stepping motor, provided with a stator assembly which includes a first stator core and a second stator core having end plate parts. The end plate parts are respectively provided with a rotor insertion hole and are disposed so as to face each other. A plurality of pole teeth which are formed to be bent and stood from an inner circumferential edge of the rotor insertion hole of one of the end plate parts are alternately arranged in a circumferential direction with a plurality of pole teeth which are formed to be bent and stood from an inner circumferential edge of the rotor insertion hole of the other of the end plate parts.

A stepping motor which is mounted on a notebook type of personal computer has been further required to be made thinner than the structure as described in the above-mentioned Patent Reference. Further, when a size of a motor is to be reduced, in order to secure a magnetic flux of a magnet as much as possible, a length of the pole teeth facing the magnet is required to make longer as much as possible. However, when the pole teeth which are bent and stood from one of the end plate parts are positioned too close to the other of the end plate parts, a magnetically short circuit may be formed. In other words, magnetic flux is short-circuited between two magnetic members. As a method for avoiding the above-mentioned magnetically short circuit, a method may be often utilized in which portions of the first stator core and the second stator core, which face tip end portions of the plurality of pole teeth formed bent and stood from the other of the end plate parts, are cut out from the rotor insertion hole of the end plate part in an outer radial direction to form cutout portions. However, when the structure as described above is utilized, a width of the end plate part can be reduced as much as possible to an extent that the cutout portion is formed although one piece of the end plate part is maintained. A size of the stepping motor is difficult to be further made thinner.

### SUMMARY OF THE INVENTION

In view of the problems described above, an embodiment of the present invention may advantageously provide a stepping motor which is capable of being made thinner even when cutout portions are formed at corresponding portions to the tip end portions of a plurality of pole teeth which are bent and stood from an opposite-side end plate part.

Thus, according to an embodiment of the present invention, there may be provided a stepping motor including a rotor having a rotor magnet and a stator assembly. The stator assembly includes a first coil and a second coil which are disposed on both sides of the rotor magnet, and a first stator core and a second stator core. Each of the first stator core and the second stator core includes an end plate part for forming a rotor insertion hole, and a plurality of pole teeth which is formed to be bent from an inner circumferential edge of the rotor insertion hole. One of the end plate parts is disposed to face the other of the end plate parts, and the pole teeth of the first stator core and the pole teeth of second stator core are alternately disposed with each other. Further, portions of one of the first and second stator cores, which face tip end portions of the pole teeth formed from the other stator core, are formed as cutout portions by cutting out in an outer radial direction from the rotor insertion hole, and each of the end plate parts is formed in a rectangular shape which has a pair of facing long sides extended in a direction where the first coil and the second coil are disposed, and at least one of the cutout portions which are located nearest to the long side is formed as a first cutout portion where the cutout portion reaches to the long side.

A magnetically short circuit may occur when the pole teeth which are formed bent and stood from one of the end plate parts are positioned too close to the other end plate part. However, in accordance with an embodiment of the present invention, portions of one of the first and the second stator cores, which face tip end portions of the pole teeth formed from the other stator core, are formed as cutout portions by cutting out in an outer radial direction from the rotor insertion hole. In addition, at least one of the cutout portions that are located nearest to the long side is formed as a first cutout portion where the cutout portion reaches to the long side. Therefore, a width of the end plate part can be made narrower in comparison with a case that the cutout portion does not reach to the long side.

In accordance with an embodiment of the present invention, each of the end plate parts of the first stator core and the second stator core are divided into two core pieces in a direction where the first coil and the second coil are disposed, and the two core pieces of the end plate part of the first stator core and the two core pieces of the end plate part of the second stator core are connected each other through a pair of the inner yokes for the first coil and the second coil. In this case, it may be structured such that a first yoke is superposed on the end plate part of the first stator core, and a second yoke is superposed on the end plate part of the second stator core, and the two core pieces of the end plate part of the first stator core are integrated with each other through the first yoke, and the two core pieces of the end plate part of the second stator core are integrated with each other through the second yoke. According to the structure in this embodiment, the end plate part of the first stator core, which is divided into two core pieces, and the end plate part of the second stator core, which is also divided into two core pieces, are respectively integrated surely. Further, it may be structured such that at least one of the first yoke and the second yoke is integrally formed as a part thereof with at least one of a pair of the inner yokes for the first coil and the second coil. In this case, number of structural component parts can be reduced.

In accordance with an embodiment, the cutout portions other than the first cutout portion are formed as second cutout portions which are formed so as to reach to an outside in a radial direction of an imaginary circumscribing circle that circumscribes a plurality of the pole teeth.

In accordance with an embodiment, one of both end portions in a circumferential direction of the first cutout portion is located at a position or its vicinity where a width dimension between the rotor insertion hole and the long side is the narrowest. According to the structure as described above, a width of a portion which is formed between the root portion of the pole teeth which is positioned on a side of the first cutout portion and the long side is widened to a side where the coil is disposed. Therefore, a magnetic loop path having a sufficient cross sectional area can be secured in which magnetic flux, which is flown from the rotor magnet and received by the pole teeth, is interlinked with the coil through the yoke and, after that, the magnetic flux flows to adjacent pole teeth. Accordingly, since magnetic saturation does not occur, a large torque can be secured.

In accordance with an embodiment, the cutout portions which are respectively located in a vicinity of the long sides of the end plate part are formed as the first cutout portion. In this case, the first stator core and the second stator core are divided into core pieces by the first cutout portion. However, the divided core pieces are integrated by connecting with each other through a yoke and thus assembling efficiency of the motor can be enhanced.

In accordance with an embodiment, a first yoke is superposed on the end plate part of the first stator core, and a face of the first yoke is contacted with a face of the end plate part of the first stator core to form a magnetic path between the first yoke and the end plate part of the first stator core through face-contact. The end plate part of the stator core and the first yoke is commonly structured by using a flat plate and thus the end plate part and the first yoke are easily formed to be face-contacted with each other. When the end plate part and the first yoke are face-contacted, more specifically, when a face of the end plate part and a face of the first yoke are contacted with each other, contacting area of the first stator core with the first yoke can be increased and thus a magnetic path is formed larger to prevent magnetic saturation. This face-contacting structure is preferably applied to the structure between the end plate part of the second stator core and the second yoke.

In accordance with the present invention, “face-contact between flat faces” means a tight contacting state between two faces and also means a state where a small gap space is formed between two faces in a case that a sufficient magnetic path is formed and required characteristics are secured.

Further, it may be structured that the first yoke includes a pair of third yokes which function as inner yokes to the first coil and the second coil, and the end plate part of the first stator core is engaged with the third yoke. According to this structure, even when the end plate part of the first stator core is divided into two core pieces, the end plate part of the first stator core can be easily integrated with each other.

In accordance with an embodiment, the stator assembly comprises an A-phase stator assembly and a B-phase stator assembly which are disposed so as to superpose on each other in a motor axial line. In this case, it may be structured such that the rotor magnet includes a first magnet portion which faces an inner peripheral face of the A-phase stator assembly and a second magnet portion which faces an inner peripheral face of the B-phase stator assembly, and a magnetized phase of the first magnet portion is shifted from a magnetized phase of the second magnet portion.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1(a) is a half sectional side view showing a stepping motor in accordance with an embodiment of the present invention in which an upper half portion is cut out, and FIG. 1(b) is its longitudinal sectional view.

FIGS. 2(a) and 2(b) are respectively plan views of stator cores which are used in a stator assembly of the stepping motor shown in FIGS. 1(a) and 1(b). FIG. 2(c) is a plan view of an end plate part of a stator assembly shown in FIGS. 2(a) and 2(b).

FIG. 3(a) is an exploded perspective view showing a stator assembly of the stepping motor shown in FIGS. 1(a) and 1(b), FIG. 3(b) is an explanatory view showing a manufacturing method for stator cores, and FIG. 3(c) is a perspective view showing the stepping motor which is exploded into the stator assembly and a rotor.

FIG. 4(a) is a half sectional side view showing a stepping motor in accordance with a second embodiment of the present invention in which an upper half portion is cut out, and FIG. 4(b) is its longitudinal sectional view.

FIG. 5(a) is an exploded perspective view showing a stator assembly of the stepping motor shown in FIGS. 4(a) and 4(b), and FIG. 5(b) is an explanatory view showing a manufacturing method for stator cores.

### DETAILED DESCRIPTION OF THE PREFERRED EMBODIMENTS

A stepping motor to which the present invention is applied will be described below with reference to the accompanying drawings.

### First Embodiment

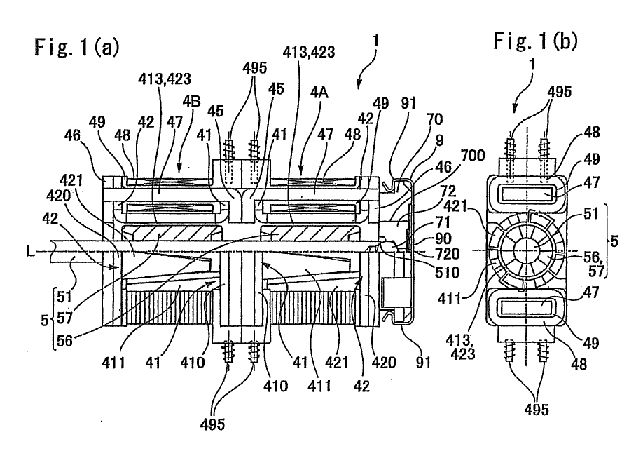

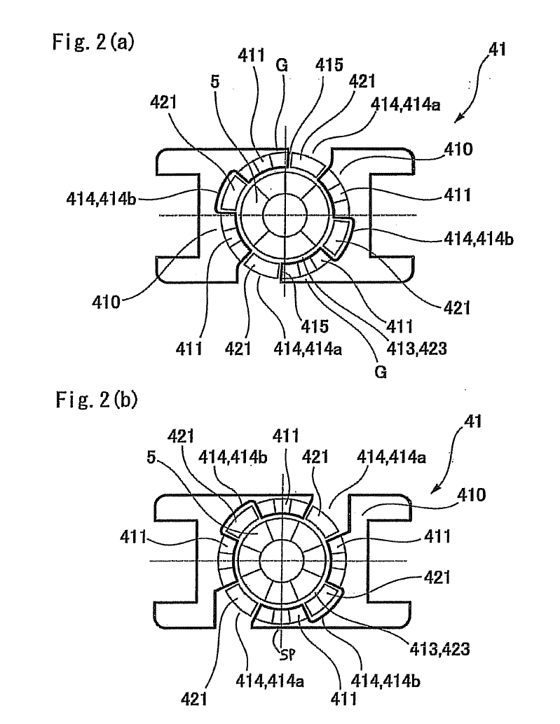

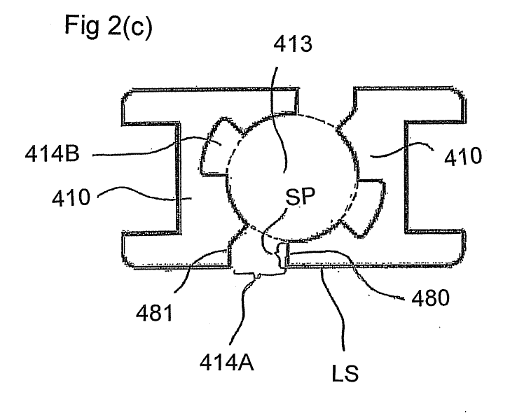

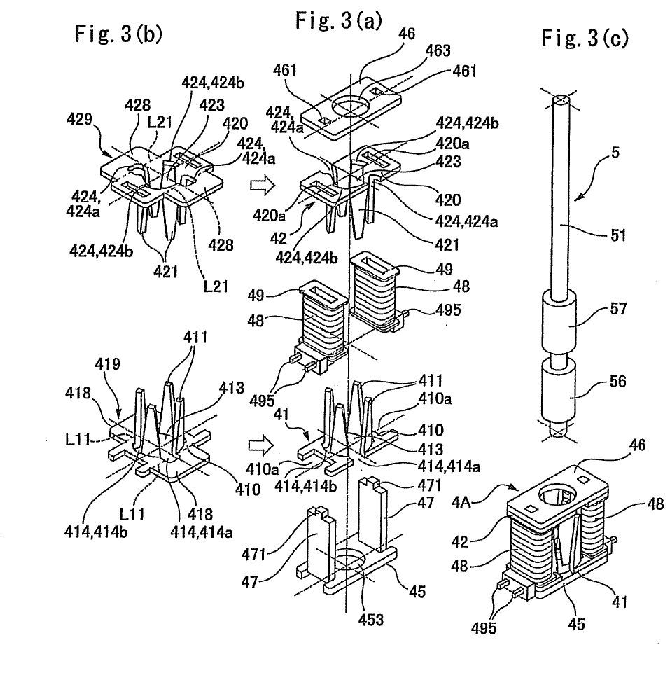

FIG. 1(a) is a half sectional side view showing a stepping motor in accordance with an embodiment of the present invention in which an upper half portion is cut out, and FIG. 1(b) is its longitudinal sectional view. FIGS. 2(a) and 2(b) are respectively plan views of stator cores which are used in a stator assembly of the stepping motor shown in FIGS. 1(a) and 1(b). In FIGS. 2(a) and 2(b), one of two stator cores is shown in a thick line and, in the other of the stator cores, only pole teeth are shown in a thin line. FIG. 3(a) is an exploded perspective view showing a stator assembly of the stepping motor shown in FIGS. 1(a) and 1(b), FIG. 3(b) is an explanatory view showing a manufacturing method for stator cores, and FIG. 3(c) is a perspective view showing the stepping motor which is exploded into the stator assembly and a rotor.

As shown in FIGS. 1(a) and 1(b), a stepping motor 1 in this embodiment is a PM type stepping motor which includes a rotor 5 provided with rotor magnets 56 and 57 and stator assemblies 4A and 4B having coils 48. An A-phase stator assembly 4A and a B-phase stator assembly 4B are disposed so as to superpose on each other along a motor axial line L. Therefore, the rotor 5 is provided with a first magnet 56 which faces an inner peripheral face of the A-phase stator assembly 4A and a second magnet 57 which faces an inner peripheral face of the B-phase stator assembly 4B. The first magnet 56 and the second magnet 57 are fixed to the rotor shaft 51.

A shaft end on a base end side of the rotor shaft 51 is supported by a bearing 72 through a steel ball 71. The steel ball 71 is held by a recessed part 510 having a conical recessed face that is formed at the shaft end of the rotor shaft 51 and by a recessed part 720 having a conical recessed face of the bearing 72. A plate-shaped bearing holder 70 made of a metal sintered body or the like is disposed at an end portion on an opposite-to-output side of the stator assembly 4A so that at least a part of the bearing holder 70 overlaps with the stator assembly 4A. The bearing 72 is mounted on a through hole 700 of the bearing holder 70. A pressurization apply member 9 made of a metal plate is disposed on the opposite-to-output side of the bearing holder 70 so that at least a part of the pressurization apply member 9 overlaps with the bearing holder 70. The pressurization apply member 9 includes four pawl parts 91 which are extended along side faces of the bearing holder 70 from an outer peripheral edge of the pressurization apply member 9 and the pressurization apply member 9 is fixed to the bearing holder 70 by the pawl parts 91 which engage with an outer peripheral edge of the bearing holder 70. The pressurization apply member 9 further includes a flat spring part 90 which is cut and bent on a bearing 72 side. The flat spring part 90 urges the bearing 72 within the through hole 700 to a side of the rotor shaft 51 and applies pressurization to the rotor shaft 51 to the front end side.

Each of the stator assemblies 4A and 4B is formed in a rectangular planar shape in which both sides of the stator assembly interposing the motor axial line L are removed. Therefore, the coils 48 are disposed in a longitudinal direction of which the long sides are extended and disposed on both sides so as to interpose the rotor magnets 56 and 57. In this embodiment, the A-phase stator assembly 4A and the B-phase stator assembly 4B are the same in their basic structures and thus only the A-phase stator assembly 4A will be described below and description for the B-phase stator assembly 4B will be added if necessary.

As shown in FIGS. 1(a), 1(b), FIG. 2(a) and FIG. 3(a), the A-phase stator assembly 4A includes a first stator core 41 and a second stator core 42. The first stator core 41 and the second stator core 42 are provided with end plate parts 410 and 420, which are formed in a flat plate shape and which have rotor insertion holes 413 and 423, and the end plate parts 410 and 420 are disposed so as to face each other. A plurality of pole teeth 411 which is bent and stood from an inner circumferential edge of the rotor insertion hole 413 of the end plate part 410 and a plurality of pole teeth 421 which is bent and stood from an inner circumferential edge of the rotor insertion hole 423 of the end plate part 420 are alternately arranged in a circumferential direction.

In the first stator core 41, portions of the end plate part 410 which face tip end portions of the plurality of pole teeth 421 of the end plate part 420 are formed as cutout portions 414 by cutting out to an outer side in a radial direction from the rotor insertion hole 413. Similarly, in the second stator core 42, portions of the end plate part 420 which face tip end portions of the plurality of pole teeth 411 of the end plate part 410 are formed as cutout portions 424 by cutting out to an outer side in a radial direction from the rotor insertion hole 423. In this embodiment, each of the end plate parts 410 and 420 is formed in a rectangular shape in which a pair of long sides of a flat plate is extended so as to face each other to a direction where the coils 48 are disposed. In accordance with this embodiment, two cutout portions of a plurality of the cutout portions 414 which are located near both of a pair of the long sides are formed as first cutout portions 414a which are cut out so as to reach to the long side from the rotor insertion hole 413. Similarly, two cutout portions of a plurality of the cutout portions 424 which are located near both of a pair of the long sides are formed as first cutout portions 424a which are cut out so as to reach to the long side from the rotor insertion hole 423. Therefore, the first stator core 41 and the second stator core 42 are respectively divided into two core pieces by the first cutout portions 414a and 424a. In the stator assembly 4A which is structured as described above, the first cutout portions 414a are largely cut out to the pole teeth 421 which are formed to be bent toward the first cutout portions 414a and thus a magnetically short circuit which may occur when the pole teeth 421 are positioned too close to the end plate part 410 is not formed. Similarly, the first cutout portions 424a are largely cut out to the pole teeth 411 which are formed to be bent toward the first cutout portions 424a and thus a magnetically short which may occur when the pole teeth 411 are positioned too close to the end plate part 420 is not formed.

In this embodiment, a structure shown in FIG. 2(a) is utilized to divide the first stator core 41 and the second stator core 42 into two core pieces by the first cutout portions 414a and 424a. In other words, an end portion 415 of both end portions in a circumferential direction of the first cutout portion 414a in the first stator core 41 is located at a position where a width dimension between the rotor insertion hole 413 and the long side of the end plate part 410 is smallest or in its vicinity. For example, there is a location SP on each end plate part 410 where the distance between an edge of the rotor insertion hole 413 and the long side LS is smallest of any possible distance from an outer edge of the rotor insertion hole and the long side. The first cutout portion 414a may be defined by a first edge 480 and a second edge 481. In the embodiment shown in FIG. 2(C), the first edge 480 is proximate to the location SP where the distance between an edge of the rotor insertion hole 413 and the long side LS is smallest. Therefore, a width of a portion “G” formed between a root portion of the pole teeth 411 positioned on a side of the first cutout portion 414a and the long side becomes wider toward a side where the coil 48 is disposed. The second stator core 42 is similarly structured to the first stator core 41 and thus its description is omitted.

In FIGS. 1(a), 1(b), FIG. 2(a) and FIG. 3(a), cutout portions other than the first cutout portions 414a and 424a among a plurality of the cutout portions 414 and 424, which are formed in the first stator core 41 and the second stator core 42, are formed as second cutout portions 414b and 424b that are formed from the rotor insertion holes 413 and 423 to a specified radial position and do not reach to the long sides of the first stator core 41 and the second stator core 42. The second cutout portions 414b and 424b are formed to a position reaching to an outer side in a radial direction of an imaginary circumscribing circle which circumscribes a plurality of the pole teeth 411 and 421. Therefore, a magnetically short circuit is not formed that may occur due to positioning of the pole teeth 411 and 421 formed in one of the end plate parts too close to the other of the end plate parts.

The first stator core 41 and the second stator core 42 having the structure as described above are formed as follows. For example, as shown in FIG. 3(b), when a sheet of magnetic plate 419 is performed with pressing work to form the rotor insertion hole 413, the pole teeth 411, the cutout portions 414 and the like, flange parts 418 are simultaneously formed on outer sides of the cutout portions for structuring the first cutout portions 414a. Similarly, a sheet of magnetic plate 429 is performed with pressing work to form the rotor insertion hole 423, the pole teeth 421, the cutout portions 424 and the like, flange parts 428 are simultaneously formed on outer sides of the cutout portions for structuring the first cutout portions 424a. After that, the flange parts 418 and 428 are cut off and removed at positions as shown by the dotted lines L11 and L21.

Also, as shown in FIGS. 1(a), 1(b) and FIG. 3(a), in this embodiment, the first stator core 41 and the second stator core 42 are disposed so as to sandwich bobbins 49 between them which include a drum part formed in a rectangular and tubular shape around which a coil 48 is wound. The bobbin 49 is structured of a resin-molded product to which terminals 495 are integrally molded and rectangular flange parts are formed on both end portions of the drum part. With respect to connection of the coils 48 with each other, when winding directions of the coils 48 are set to be the same and serially connected, a bipolar drive is obtained. On the other hand, when winding directions are set to reverse to each other and serially connected and, in addition, when electric power is supplied from its connecting point, a unipolar drive is obtained.

A first yoke 45 which is formed in a flat plate shape is superposed on an outer side of the end plate part 410 of the first stator core 41. In other words, an upper face of the first yoke 45 is superposed so as to face-contact with an under face of the end plate part 410. Therefore, contacting area of the first stator core 41 with the first yoke 45 is increased to form a larger magnetic path. Further, a second yoke 46 which is also formed in a flat plate shape is superposed on an outer side of the end plate part 420 of the second stator core 42. In other words, an under face of the second yoke 46 is superposed so as to face-contact with an upper face of the end plate part 420. Therefore, contacting area of the second stator core 42 with the second yoke 46 is increased to form a larger magnetic path. The first yoke 45 is formed with a pair of third yokes 47 which are bent and stood from the first yoke 45 on both side positions interposing the rotor insertion hole 453. The third yokes 47 function as an inner yoke for the coil 48. Further, the end plate parts 420 of the second stator core 42 are formed with rectangular holes 420a, to which tip end portions of the third yokes 47 are fitted and which are face-contacted with the third yokes 47, on both sides so as to interpose the rotor insertion hole 423. Rectangular recessed parts 410a, to which root portions of the third yokes 47 are fitted and which are face-contacted with the third yokes 47, are formed on an end portion of the end plate parts 410 of the first stator core 41. Therefore, the rectangular recessed part 410a formed in the end plate part 410 of the first stator core 41 is also face-contacted with the root portion of the third yoke 47 which is integrally formed to be bent from the first yoke 45 and thus contacting area of the first stator core 41 with the third yoke 47, i.e., the first yoke 45 can be largely secured to form a large magnetic path.

In addition, a small projection 471 is formed at a center portion in a widthwise direction on a tip end portion of the third yoke 47 and the second yoke 46 is formed with small holes 461, to which the small projection 471 is fitted, on both sides of the rotor insertion hole 463. Therefore, the first stator core 41, the bobbins 49, the second stator core 42 and the second yoke 46 are superposed on the first yoke 45 and, at the same time, the small projections 471 of the third yokes 47 are fitted to the small holes 461 of the second yoke 46. As a result, the A-phase stator assembly 4A shown in FIG. 3(c) is structured. As described above, even when the first stator core 41 and the second stator core 42 are respectively divided into two core pieces by the first cutout portions 414a and 414b, the first stator core 41 and the second stator core 42 are integrated through connection by using the first yoke 45, the second yoke 46 and the third yoke 47. Further, the first stator core 41, the second stator core 42, the first yoke 45, the second yoke 46 and the third yoke 47 are surely connected with each other and the respective members have a function to form a magnetic path and thus the stator assembly 4A is provided with a sufficient magnetic path.

The B-phase stator assembly 4B is structured similarly to the A-phase stator assembly 4A. When the A-phase stator assembly 4A and the B-phase stator assembly 4B are superposed along the motor axial line “L”, the respective rotor insertion holes 453, 413, 423 and 463 overlap each other which are respectively formed in the first yoke 45, the first stator core 41, the second stator core 42 and the second yoke 46. Therefore, the stepping motor 1 can be assembled by inserting the rotor 5 into the inner side of the rotor insertion holes 453, 413, 423 and 463.

As described above, in the first stator core 41 and the second stator core 42 of the stator assemblies 4A and 4B, when the pole teeth 411 and 421 formed from one of the end plate parts are located too close to the other of the end plate parts, a magnetically short circuit may occur. Therefore, in this embodiment, in the first stator core 41 and the second stator core 42, portions of one of the end plate parts which face tip end portions of a plurality of the pole teeth 411 and 421 of the other of the end plate parts are formed as cutout portions 414 and 424 by cutting out to an outer side in the radial direction from the rotor insertion holes 413 and 423. In addition, two cutout portions 414 and 424 among the cutout portions 414 and 424 which are located near the long sides are formed as first cutout portions 414a and 424a which are cut out so as to reach to the long sides from the rotor insertion holes 413 and 423. Therefore, in comparison with a case that the end plate parts 410 and 420 are not divided into two core pieces, the width of the end plate parts 410 and 420 can be made narrower. Accordingly, the size of the stepping motor 1 can be made thinner.

Further, the first cutout portions 414a are largely cut out for the pole teeth 421 which are formed to be bent toward the first cutout portions 414a and thus a magnetically short circuit which may occur due to positioning of the pole teeth 421 too close to the end plate part 410 is not formed. Similarly, the first cutout portions 424a are largely cut out for the pole teeth 411 which are formed to be bent toward the first cutout portions 424a and thus a magnetically short circuit which may occur due to positioning of the pole teeth 411 too close to the end plate part 420 is not formed. Also, cutout portions other than the first cutout portions 414a and 424a among a plurality of the cutout portions 414 and 424 are formed as the second cutout portions 414b and 424b which are formed from the rotor insertion holes 413 and 423 to a position reaching to an outer side in the radial direction of an imaginary circumscribing circle that circumscribes a plurality of the pole teeth 411 and 421. Therefore, a magnetically short circuit which may occur due to positioning of the pole teeth 411 too close to the end plate part 420 is not formed, and a magnetically short circuit which may occur due to positioning of the pole teeth 421 too close to the end plate part 410 is not also formed.

In addition, in this embodiment, as described with reference to FIG. 2(a), the end portion 415 in the circumferential direction of the first cutout portion 414a is located at a position where a width dimension between the rotor insertion hole 413 and the long side is the smallest or in its vicinity. Therefore, the width of the portion “G” between the root portion of the pole teeth 411 and 421 which is positioned on a side of the first cutout portions 414a and 424a and the long side becomes wider toward a side where the coil 48 is disposed. Accordingly, a magnetic loop path having a sufficient cross sectional area can be secured in which magnetic flux, which is flown from the rotor magnets 56 and 57 and received by the pole teeth 411 and 421, is interlinked with the coils 48 through the first yoke 45, the second yoke 46 and the third yoke 47 and, after that, the magnetic flux flows to adjacent pole teeth 411 and 421.

Further, the end plate part 410 of the first stator core 41 which is located on the root portion of the pole teeth 411 is face-contacted with the flat plate-shaped first yoke 45 and thus contacting area of the end plate part 410 and the first yoke 45 is secured larger to form a large magnetic path. In addition, the third yoke 47 is integrally formed in the first yoke 45 and the root portion of the third yoke 47 is engaged with the rectangular recessed part 410a, which is formed in the end plate part 410 of the first stator core 41, and the third yoke 47 is face-contacted with the end plate part 410. Therefore, also in this manner, the magnetic path is formed between the end plate part 410 and the third yoke 47. Accordingly, a magnetic path between the end plate part 410 having the pole teeth 411 and the third yoke 47 on which the coil 48 is disposed is formed through face-contact of the end plate part 410 with the first yoke 45 and, in addition, through face-contact of the end plate part 410 and the third yoke 47. As a result, the magnetic path can be formed larger and thus occurrence of magnetic saturation can be prevented.

Further, a magnetic path is secured between the end plate part 420 having the pole teeth 421 and the second yoke 46 through face-contact of the end plate part 420 with the second yoke 46 and, in addition, the tip end portion of the third yoke 47 is fitted into the end plate part 420 to magnetically connect with the end plate part 420 through the rectangular hole 420a which is face-contacted with the third yoke 47. Therefore, a magnetic loop path with a sufficient cross sectional area can be secured in which magnetic flux from the rotor magnet 56 which is received with the pole teeth 411 and 421 is interlinked with the coils 48 through the first yoke 45, the second yoke 46 and the third yoke 47 and then flows to adjacent pole teeth 421 and 411. Accordingly, since magnetic saturation does not occur, a large torque can be secured.

Further, as a comparison embodiment of the present invention, as shown in FIG. 2(b), the first cutout portions 414a and 424a may be formed at portions or locations different from the location SP where the width dimension between an edge of the rotor insertion holes 413 and 423 and the long sides is the smallest. However, in this embodiment, an entire width dimension is narrow between the root portions of the pole teeth 411 and 421, which are positioned on a side of the first cutout portions 414a and 424a, and the long sides. Therefore, a cross sectional area of a magnetic loop path for magnetic flux which is flown from the rotor magnets 56 and 57 and received by the pole teeth 411 and 421 becomes smaller in comparison with the structure shown in FIG. 2(a). Accordingly, the structure shown in FIG. 2(a) is preferable because it is difficult to produce magnetic saturation and a large torque can be secured.

In addition, in this embodiment, the first stator core 41 and the second stator core 42 are divided into two core pieces by the first cutout portions 414a and 424a. However, the divided core pieces are connected and integrated with each other through the first yoke 45, the second yoke 46 and the third yoke 47 and thus assembling efficiency of the stepping motor 1 can be enhanced.

### Second Embodiment

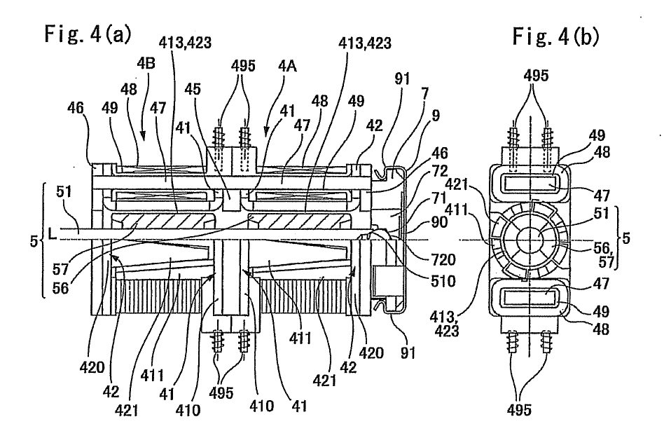

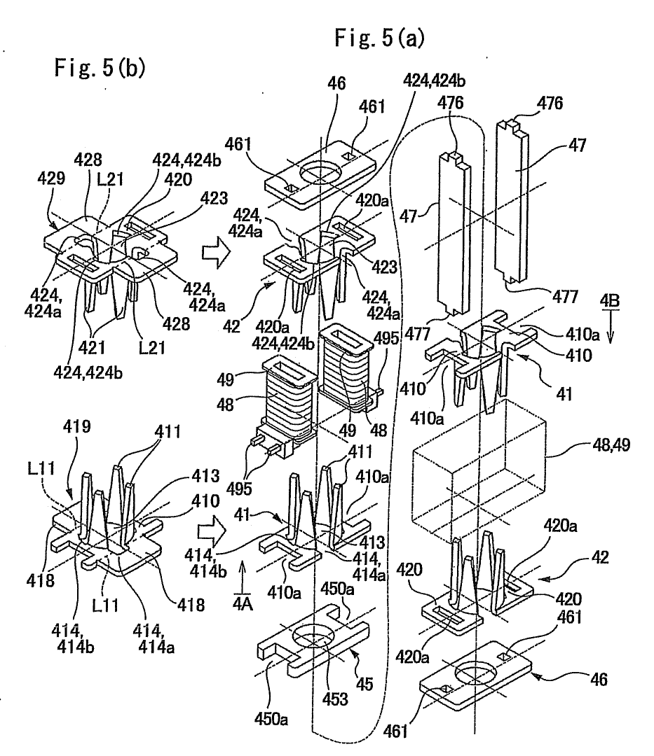

FIG. 4(a) is a half sectional side view showing a stepping motor in accordance with a second embodiment of the present invention in which an upper half portion is cut off, and FIG. 4(b) is its longitudinal sectional view. FIG. 5(a) is an exploded perspective view showing a stator assembly of the stepping motor shown in FIGS. 4(a) and 4(b), and FIG. 5(b) is an explanatory view showing a manufacturing method for stator cores. Basic structure in the second embodiment is similar to that in the first embodiment and thus the same notational symbols are used in the same portions and their descriptions are omitted.

A stepping motor 1 shown in FIGS. 4(a) and 4(b) is, similarly to the first embodiment, a PM type stepping motor which includes a rotor 5 provided with rotor magnets 56 and 57 and stator assemblies 4A and 4B having coils 48. An A-phase stator assembly 4A and a B-phase stator assembly 4B are disposed so as to superpose on each other along a motor axial line L. Therefore, the rotor 5 is provided with a first magnet 56 which faces an inner peripheral face of the A-phase stator assembly 4A and a second magnet 57 which faces an inner peripheral face of the B-phase stator assembly 4B. The first magnet 56 and the second magnet 57 are fixed to the rotor shaft 51. Each of the stator assemblies 4A and 4B is formed in a rectangular planar shape (bottomed shape) in which both sides of the stator assembly interposing the motor axial line L are removed. Therefore, the coils 48 are disposed in an extended longitudinal direction of the sides and on both sides so as to interpose the rotor magnets 56 and 57. Further, in the first stator core 41, portions of the end plate part 410, which face tip end portions of the plurality of pole teeth 421 of the end plate part 420, are formed as cutout portions 414 by cutting out to an outer side in the radial direction from the rotor insertion hole 413. Similarly, in the second stator core 42, portions of the end plate part 420, which face tip end portions of the plurality of pole teeth 411, are formed as cutout portions 424 by cutting out to an outer side in the radial direction from the rotor insertion hole 423. In this embodiment, the end plate parts 410 and 420 are formed in a rectangular shape in which a pair of long sides is extended so as to face each other to a direction where the coils 48 are disposed. In this case, two cutout portions of a plurality of the cutout portions 414 and 424 which are located nearest to a pair of the long sides are formed as first cutout portions 414a and 424a which are cut out so as to reach to the long side from the rotor insertion holes 413 and 423. Therefore, the first stator core 41 and the second stator core 42 are respectively divided into two core pieces by the first cutout portions 414a and 424a.

The first stator core 41 and the second stator core 42 having the structure as described above are also manufactured as follows. For example, as shown in FIG. 5(b), when a sheet of magnetic plate 419 (429) is performed with pressing work to form the rotor insertion hole 413 (423), the pole teeth 411 (421), the cutout portions 414 (424) and the like, flange parts 418 (428) are simultaneously formed on outer sides of the cutout portions for structuring the first cutout portions 414a (424a). After that, the flange parts 418 (428) are cut off and removed at positions as shown by the dotted line L11 (L21).

In the A-phase stator assembly 4A in accordance with the second embodiment shown in FIGS. 4(a), 4(b) and FIG. 5(a), a first yoke 45 which is formed in a flat plate shape is superposed on an outer side of the end plate part 410 of the first stator core 41 and a second yoke 46 which is also formed in a flat plate shape is superposed on an outer side of the end plate part 420 of the second stator core 42. In this manner, the end plate part 410 is face-contacted with the flat plate-shaped first yoke 45 and the end plate part 420 is face-contacted with the flat plate-shaped second yoke 46. Also in the B-phase stator assembly 4B, a first yoke 45 formed in a flat plate shape is to be superposed on an outer side of the end plate part 410 of the first stator core 41. In this embodiment, the first yoke 45 used in the A-phase stator assembly 4A is also used in the B-phase stator assembly 4B as the first yoke.

In the second embodiment, third yokes 47 functioning as an inner yoke for the coils 48 are used but, in this embodiment, the third yokes 47 are separately formed from the first yoke 45, which is different from the first embodiment. Therefore, in the first stator core 41, rectangular recessed parts 410a, to which the third yokes 47 are fitted and with which the third yokes 47 are face-contacted, are formed on both sides of the first stator core 41 so as to interpose the rotor insertion hole 413. Also, in the end plate part 420 of the second stator core 42, rectangular holes 420a, into which the third yokes 47 are fitted and with which the end plate part 420 of the second stator core 42 are face-contacted, are formed on both sides of the second stator core 42 so as to interpose the rotor insertion hole 423.

Further, rectangular recessed parts 450a to which the third yokes 47 are fitted are formed on both end portions of the first yoke 45. Further, small projections 476 and 477 are formed at center portions in a widthwise direction of both end portions of the third yoke 47. Also, small holes 461 into which the small projections 476 and 477 of the third yoke 47 are fitted are formed in the second yoke 46 of the A-phase stator assembly 4A and the second yoke 46 of the B-phase stator assembly 4B. Therefore, the third yokes 47 are fitted to and face-contacted with the rectangular recessed parts 450a of the first yoke 45, and then the first stator core 41, the bobbins 49, the second stator core 42 and the second yoke 46 are fitted to third yokes 47 from the both sides and, after that, the small projections 476 and 477 of the third yokes 47 are fitted into the small holes 461 of the second yoke 46. As a result, the stator assemblies 4A and 4B are structured. As described above, even when the first stator core 41 and the second stator core 42 are respectively divided into two core pieces by the first cutout portions 414a and 424a, the first stator core 41 and the second stator core 42 are integrated through connection by using the first yoke 45, the second yoke 46 and the third yoke 47. Therefore, the stepping motor 1 can be assembled easily. Further, the first stator core 41, the second stator core 42, the first yoke 45, the second yoke 46 and the third yoke 47 are surely connected with each other through their face-contacts and the respective members have a function to form a magnetic path and thus the stator assemblies are provided with a sufficient magnetic path.

### Other Embodiments

In the stepping motor 1 as described above, it may be structured in which positional relationship of the pole teeth 411 and 421 in the A-phase stator assembly 4A and the B-phase stator assembly 4B is set to be the same and magnetized phase of the first magnet 56 facing the inner peripheral face of the A-phase stator assembly 4A is shifted to the second magnet 57 facing the inner peripheral face of the B-phase stator assembly 4B. According to the structure as described above, the rotor 5 can be rotated and freely controlled in a normal and reverse direction by controlling excitation for the respective phases. The phases of the magnetized magnets 56 and 57 may be shifted with 45° for four poles, 22.5° for eight poles or 11.25° for 16 poles.

Further, in the embodiments described above, the first cutout portions 414a and 424a are disposed in both of two long sides of the end plate parts 410 and 420 which face each other. However, the first cutout portions 414a and 424a may be formed in only one of the long sides which face each other. Also in this case, a width of the end plate parts 410 and 420 can be narrowed in comparison with the conventional example and thus the stepping motor 1 can be made thinner. Further, in the embodiment described above, a pair of the third yokes 47 are integrally formed with the first yoke 45. However, a pair of the third yokes 47 may be integrally formed with the second yoke 46 and, alternatively, each of a pair of the third yokes 47 may be integrally formed with the first yoke 45 and the second yoke 46. Further, when holding and holding strength of the end plate parts 420 of the second stator core 42 are sufficiently secured by a pair of the third yokes 47, the second yoke 46 may be omitted.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A stepping motor comprising:
a rotor having a rotor magnet; and
a stator assembly comprising:
a first coil and a second coil which are disposed on both sides of the rotor magnet;
a first stator core and a second stator core, each of which comprising:
an end plate part for forming a rotor insertion hole; and
a plurality of pole teeth which is formed to be bent from an inner circumferential edge of the rotor insertion hole;
wherein one of the end plate parts is disposed to face the other of the end plate parts, and the plurality of pole teeth of the first stator core and the plurality of pole teeth of second stator core are alternately disposed with each other,
wherein portions of one of the first and the second stator cores, which face tip end portions of the pole teeth formed from the other stator core, are formed as cutout portions by cutting out in an outer radial direction from the rotor insertion hole,
wherein each of the end plate parts is formed in a rectangular shape which has a pair of facing long sides extended in a direction where the first coil and the second coil are disposed, and
wherein at least one of the cutout portions which are located nearest to the long sides is formed as a first cutout portion where the cutout portion reaches to the long side.

2. The stepping motor according to claim 1, wherein the cutout portions other than the first cutout portion are formed as second cutout portions which are formed so as to reach to an outside in the outer radial direction of an imaginary circumscribing circle that circumscribes a plurality of the pole teeth.

3. The stepping motor according to claim 1, wherein each end plate portion further comprises:
a location where the distance between an outer edge of the rotor insertion hole and the long side is the smallest of any possible distance from an outer edge of the rotor insertion hole to the long side;
a first edge; and
a second edge;
wherein the first cutout portion is a cutout space defined between the first edge and the second edge of the end plate portion, and the first edge is located proximate to the position where the distance between the outer edge of the rotor insertion hole and the long side is the smallest of any possible distance from an outer edge of the rotor insertion hole to the long side.

4. The stepping motor according to claim 3, wherein the cutout portions which are located in a vicinity of the long sides of the end plate part are formed as the first cutout portion.

5. The stepping motor according to claim 4, wherein the first stator core and the second stator core are respectively divided into two core pieces by the first cutout portion and the two core pieces are integrated with each other by using a yoke.

6. The stepping motor according to claim 1, further comprising a first yoke which is superposed on the end plate part of the first stator core,
wherein a face of the first yoke is contacted with a face of the end plate part of the first stator core to form a magnetic path between the first yoke and the end plate part of the first stator core through face-contact.

7. The stepping motor according to claim 6, wherein the end plate part of the first stator core is formed of two core pieces which are divided by the first cutout portion and the two divided core pieces are connected with each other through the first yoke.

8. The stepping motor according to claim 6, wherein the first yoke includes a pair of third yokes which function as inner yokes to the first coil and the second coil, and the end plate part of the first stator core is engaged with the third yoke.

9. The stepping motor according to claim 6, further comprising a second yoke which is superposed on the end plate part of the second stator core,
wherein a face of the second yoke is contacted with a face of the end plate part of the second stator core to form a magnetic path between the second yoke and the end plate part of the second stator core through face-contact.

10. The stepping motor according to claim 1, wherein the stator assembly comprises an A-phase stator assembly and a B-phase stator assembly which are disposed so as to superpose on each other in a motor axial line.

11. The stepping motor according to claim 10, wherein the rotor magnet includes a first magnet portion which faces an inner peripheral face of the A-phase stator assembly and a second magnet portion which faces an inner peripheral face of the B-phase stator assembly, and a magnetized phase of the first magnet portion is shifted from a magnetized phase of the second magnet portion.

12. A stepping motor comprising:
a rotor having a rotor magnet; and
a stator assembly comprising:
a first coil and a second coil which are disposed on both sides of the rotor magnet;
a first stator core and a second stator core, each comprising an end plate part for forming a rotor insertion hole, and one of the end plate parts being disposed to face the other of the end plate parts; and
a pair of inner yokes for the first coil and the second coil;
wherein each of the end plate parts of the first stator core and the second stator core are divided into two core pieces in a direction where the first coil and the second coil are disposed, and
wherein the two core pieces of the end plate part of the first stator core and the two core pieces of the end plate part of the second stator core are connected to each other through the pair of inner yokes for the first coil and the second coil.

13. The stepping motor according to claim 12, further comprising:
a first yoke which is superposed on the end plate part of the first stator core; and
a second yoke which is superposed on the end plate part of the second stator core;
wherein the two core pieces of the end plate part of the first stator core are integrated with each other through the first yoke, and the two core pieces of the end plate part of the second stator core are integrated with each other through the second yoke.

14. The stepping motor according to claim 13, wherein a face of the first yoke is contacted with a face of the end plate part of the first stator core to form a magnetic path between the first yoke and the end plate part of the first stator core through face-contact, and
wherein a face of the second yoke is contacted with a face of the end plate part of the second stator core to form a magnetic path between the second yoke and the end plate part of the second stator core through face-contact.

15. The stepping motor according to claim 14, wherein the first yoke integrally includes a pair of the inner yokes for the first coil and the second coil, and the end plate part of the first stator core is positioned by a pair of the inner yokes which is engaged with the end plate part of the first stator core.

16. The stepping motor according to claim 12, wherein at least one of the first yoke and the second yoke is integrally formed with at least one of a pair of the inner yokes for the first coil and the second coil as a part thereof.
